(19) United States
(12) Patent Application Publication
(10) Pub. No.: US 2006/0109364 A1
(43) Pub. Date: May 25, 2006

(54) Refracting device for display of digital camera

(76) Inventor: Chia-Chi Sun, Taipei (TW)

Correspondence Address: BACON & THOMAS, PLLC, 625 SLATERS LANE, FOURTH FLOOR, ALEXANDRIA, VA, 22314, US

(21) Appl. No.: 10/994,325

(22) Filed: Nov. 23, 2004

(51) Int. Cl. H04N 5/225; H04N 5/222; G03B 13/08

(52) U.S. Cl. 348/333.06; 348/341; 348/375; 396/385

(57) ABSTRACT

The present invention is a refracting device for display of digital camera. Specifically, it is a digital camera in which the display for showing image captured from lens is installed with a refracting device, such that the user can view the image from display in optical dead-zone, the visual angle is thus broadened. The refracting device at least includes a pair of pivot bases, wherein each pivot bases is installed with a rotating arm, and a reflecting plate is connected to the rotating arm, such that the reflecting plate can turn over or back in accordance with the viewpoint of user and thus allow the user a free view-finding.

### BACKGROUND OF THE INVENTION

1) Field of the Invention

The present invention relates to a refracting device for display of digital camera, more specifically, to a refracting device installed around the image display. By way of refraction on the mirror face, the user is allowed to view the image on the display from another visual angle.

2) Description of the Prior Art

Digital camera typically is installed with a display, such that the user can view the captured picture immediately. Therefore, the users generally do not perform aiming or focusing through the traditional window while taking a picture, unless the object stay in a special environment or is illuminated by unusual beams. The said display can be classified as a small scale Liquid Crystal Display (LCD, for short), which is a kind of flat display among opto-electronic products, and features small volume, light weight, thin thickness, low power consumption, flash-free, radiation-free. However, generally speaking, as LCD is applied to display based on the effect of electro-optical and the characteristic of polarized light, which have the deficiency of optical dead-zone, i.e., the image on the display becomes invisible when the visual angle of user is significantly slanted or beyond the refracting angle of LCD image, the range of view-finding is limited. Therefore, for the user who has to raise or lay down the digital camera or take the picture of wide range, which is possible especially at a multitudinous scene or at the occasion that needs special view-finding angle, the LCD display becomes invisible and useless.

To solve those deficiencies stated above, the inventor designed a refracting device such that, in an optical dead-zone, the user can view the display image through the refraction and thus ameliorates the deficiencies disclosed above.

### SUMMARY OF THE INVENTION

The main objective of this refracting device for display of digital camera is to provide a refracting device, such that, by way of the refraction, even in an optical dead-zone, the user can view the image shown on the display, the effective visual angle of view-finding is significantly increased, and the problem caused by optical dead-zone of LCD display is thus solved.

To further describe the technical details of the present invention, the preferred embodiments together with the accompanying drawings are described in the following.

### BRIEF DESCRIPTION OF THE DRAWINGS

FIG. 1 is a composite view of the present invention.

FIG. 2 is an operational view of the present invention.

FIG. 3 is another operational view of the present invention.

FIG. 4 is an exploded view of another embodiment of the present invention.

FIG. 5 is an operational view of another embodiment of the present invention.

### DETAILED DESCRIPTION OF THE PREFERRED EMBODIMENTS

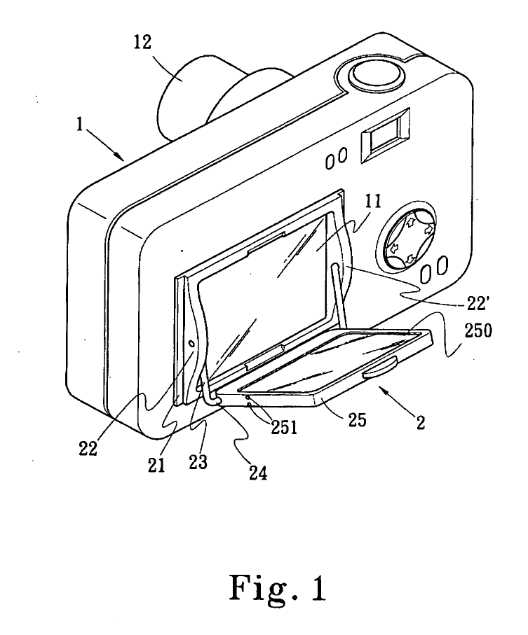

Firstly, referring to FIG. 1, in which the refracting device 2 according to the present invention is installed around the LCD display 11 of digital camera 1. The LCD display 11 mainly is used for immediately showing picture captured from lens 12, or showing the pictures stored in memory card, or showing the settings of digital camera 1. Thus display 11 is an object that the user has to view when operating the digital camera.

As described above, display 11 has the deficiency of optical dead-zone, that is, the image on the display will be invisible when the visual angle of user is significantly slanted. Therefore, the inventor utilizes a refracting device 2 and installs it on the LCD display 11. The refracting device 2 at least includes: a frame 21, a pair of opposite pivot bases 22, 22′, and rotating arms 23, an axle 24 which horizontally connects the rotating arms 23 and penetrates and holds a reflecting plate 25, convex parts 251 provided at both sides of reflecting plate 25 are used for locating when the refracting device 2 is restored. The said reflecting plate 25 can be flipped over and back to regenerate the image of display 11 on its mirror face 250 to cater to the different visual angles and positions of user. Thus the problem caused by optical dead-zone of LCD display is solved, and the effective range of visual angle is significantly increased.

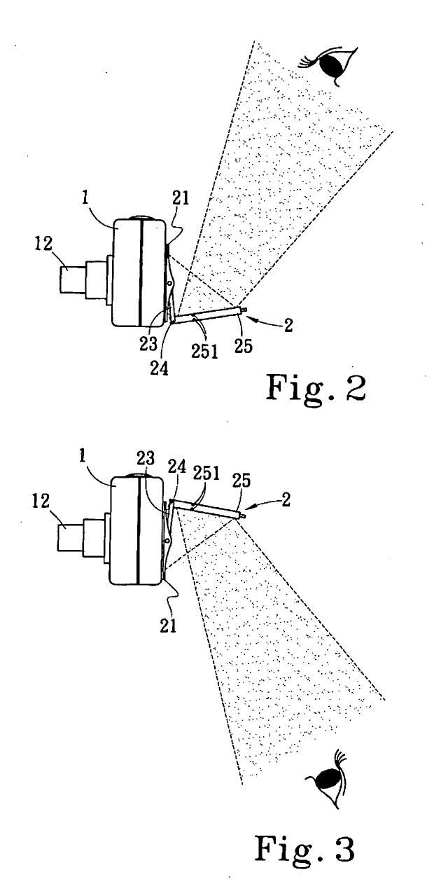

To continue, referring to FIG. 2 and FIG. 3, at a multitudinous scene (e.g., an exhibition, a press conference, or a show, and so on.) or at the occasion that demands large view-finding angle, the digital camera 1 has to be raised up or laid down, the user can rotate reflecting plate 25 and adjust its angle through the operation of rotating arm 23, to make the mirror face 250 of reflecting plate 25 precisely map to display 11. In this way, the effective range of visual angle is significantly increased, the problem caused by invisible LCD display is solved, and the user becomes less constrained by the optical dead-zone.

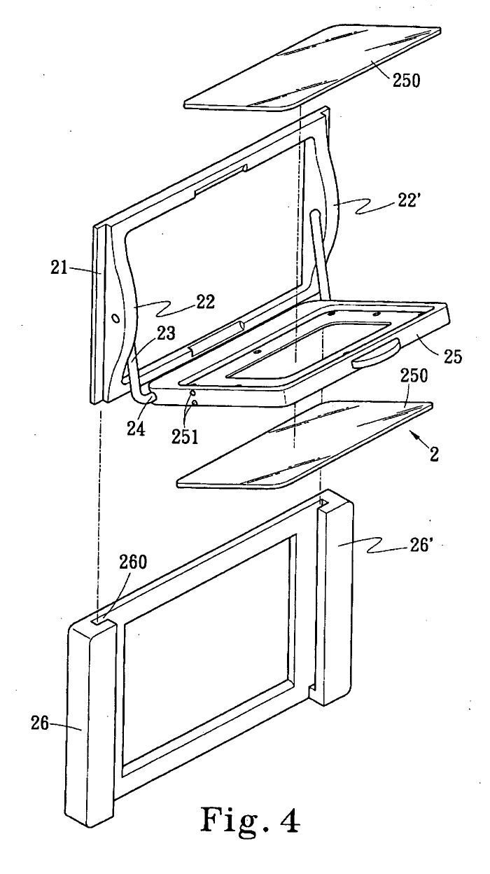

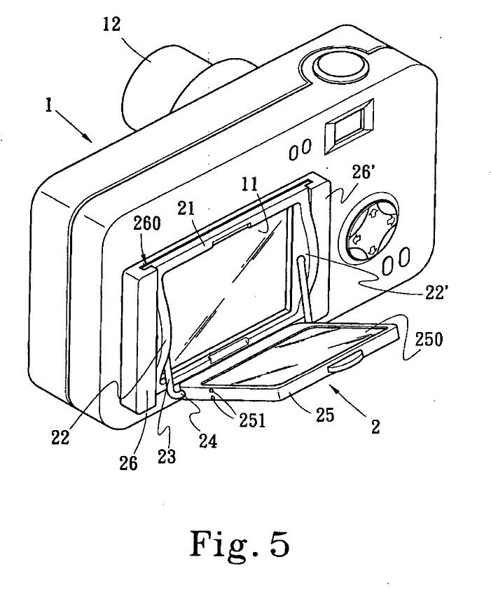

Moreover, referring to FIG. 4, the refracting device 2 of the present invention is further installed with a pair of track bases 26, 26′. Sliding slots 260 are provided at both sides of the track bases 26, 26′. The space of sliding slots 260 matches the thickness of frame 21 of refracting device 2, such that the refracting device 2 can be embedded into the sliding slot 260 of the track bases 26, 26′ to perform combination. The track bases 26, 26′ are provided to meet the need of commercially available digital cameras. Referring to FIG. 5, the track bases 26, 26′ can be fixed at both sides on the display 11 of digital camera 1 to accept the embedment of frame 21 of refracting device 2 and match the frame 21 to the display 11. After adjusting the rotating arms 23, 24 upwards or downwards, the mirror face 250 of reflecting plate 25 can precisely map to the display 11, and the user can break through the constraint of optical dead-zone. Therefore, Track bases 26, 26′ are components designed especially for the old-style or existing digital cameras.

By way of the structural design of the tracking bases 26, 26′ and refracting device 2, the refracting device 2 becomes unlimited by the installation. Consequently, the refracting device 2 can be embedded into digital camera or other information appliances having LCD display.

1. A refracting device for display of digital camera, which is installed around the display of digital camera, and let the user view the displayed image in optical dead-zone through refraction; the said refracting device at least includes:
a frame, which has a larger size than the display does, in order to be framed around the display, and the frame has a pair of opposite pivot bases to hold the rotating arm;
a rotating arm, which is a rotatable joint arm pivotally connected by one or more than one rotating arm, with one end pivotally connecting at the pivot base of frame and the other end pivotally connecting at the reflecting plate;
reflecting plate, which is provided for refracting the image from the display;
such that, the reflecting plate can be flipped over and back by way of the pivoting of rotating arm, to show the display in accordance with the visual angles and positions of user, to significantly increase the effective range of visual angle of user, and thus solve the problem caused by optical dead-zone of LCD display.

2. A refracting device for display of digital camera as claimed in claim 1, wherein the reflecting plate has a mirror face made from glass and is reflective.

3. A refracting device for display of digital camera, which is installed around the display of digital camera, and let the user view the displayed image in optical dead-zone through refraction; what the said refracting device provides for the existing digital cameras at least includes:
a frame, which has a larger size than the display does, in order to be framed around the display, and the frame has a pair of opposite pivot bases to hold the rotating arm;
a rotating arm, which is a rotatable joint arm pivotally connected by one or more than one rotating arm, with one end pivotally connecting at the pivot base of frame and the other end pivotally connecting at the reflecting plate;
reflecting plate, which is provided for refracting the image from the display;
a pair of tracking bases, which are fixed at both sides of display, and provide sliding slots to accept the embedment of frame;
such that, by way of the structural design of tracking bases, the installation of refracting device is not constrained.

4. A refracting device for view-finding visual angle as claimed in claim 3, wherein the space of sliding slots in tracking bases match the thickness of frame.
